(19) United States
(12) Patent Application Publication
(10) Pub. No.: US 2026/0109223 A1
(43) Pub. Date: Apr. 23, 2026

(54) SYSTEM AND METHOD FOR GENERATING AD HOC ACTIONABLE USER INTERFACE AND USER EXPERIENCE

(71) Applicant: GM GLOBAL TECHNOLOGY OPERATIONS LLC, Detroit, MI (US)

(72) Inventors: Hadar Geva, Hertzliya (IL); Omer Tsimhoni, Bloomfield Hills, MI (US); Ohad Akiva, Kfar Saba (IL); Elior Hadad, Ness Tziona (IL); Benjamin Roth, Oak Park, MI (US)

(73) Assignee: GM GLOBAL TECHNOLOGY OPERATIONS LLC, Detroit, MI (US)

(21) Appl. No.: 18/924,966

(22) Filed: Oct. 23, 2024

(51) Int. Cl. B60K 35/28; B60K 35/22

(52) U.S. Cl. CPC B60K 35/28; B60K 35/22; B60K 2360/164

(57) ABSTRACT

A system for generating in real-time an ad hoc actionable user interface (UI) and user experience (UX) includes one or more data sources, a visual display device for presenting actionable visual screens, and an input device for receiving external triggers. The system also includes an electronic controller programmed with UI and UX algorithms. The UI algorithm receives, from the input device, a trigger event and, from the data source(s), data contextually related to the received trigger event. The UI algorithm also determines an expected user inquiry in response to the received trigger event and contextually related data. The UI algorithm additionally generates actionable visual screen(s) having user prompt(s) corresponding to the determined expected user inquiry. The UX algorithm selects and presents on the visual display device an actionable visual screen from the generated screen(s) to generate the ad hoc actionable UI and UX.

### INTRODUCTION

The present disclosure relates to a system and a method for generating an ad hoc actionable user interface and user experience.

Generally, a user interface (UI) is the means by which a computer system user and the computer system interact. More specifically, a user interface is a point of human-computer interaction and communication in a device. Such an interface typically involves the use of input devices and software, such as display screens, keyboards, a computer mouse, and the appearance of a desktop.

A user interface also defines how a user interacts with a computer application program or a website, using visual and audio elements, such as type fonts, icons, buttons, animations, and sounds. The goal of such human-computer interaction is to allow practical operation and control of the machine from the human end, while the machine simultaneously feeds back information that aids the operator's decision-making process. An effective user interface adheres to design principles that enable a user to navigate through the interface and easily utilize it for the intended purpose.

### SUMMARY

A system for generating in real-time an ad hoc actionable user interface (UI) and user experience (UX) includes at least one data source, a visual display device configured to present actionable visual screens, and an input device configured to receive external triggers. The system also includes an electronic controller in communication with the data source(s), the visual display device, and the input device and programmed with a UI algorithm and a UX algorithm. The UI algorithm is configured to receive, from the input device, a trigger event and, from the data source(s), data contextually related to the received trigger event. The UI algorithm is also configured to determine an expected user inquiry in response to the received trigger event and contextually related data received from the data source(s). The UI algorithm is further configured to generate at least one actionable visual screen, each having one or more user prompts corresponding to the determined expected user inquiry. The UX algorithm is configured to select and present on the visual display device an actionable visual screen from the at least one generated actionable visual screen to thereby generate the ad hoc actionable UI and UX.

Each of the visual display device, the input device, and the electronic controller may be a component of a vehicle infotainment system.

The data source(s) may include at least one of a vehicle sensor, an information technology (IT) cloud server, and the World Wide Web (WWW).

The UI algorithm may be configured to determine, i.e., predict, the expected user inquiry via an artificial intelligence (AI) agent.

The UX algorithm may use Markov Decision Process (MDP) to determine the expected user inquiry.

The expected user inquiry may be determined via optimization of a reward function defined using the trigger event and the contextually related data.

The UI algorithm may be additionally configured to construct, in real-time, a software code configured to select a design and a layout of the actionable visual screen(s).

The constructed software code may include access to a UI formulator configured to generate the actionable visual screen(s).

The UI formulator may include access to a generative adversarial network (GAN). The GAN may include a design originator function configured to generate a set of alternative actionable visual screens. The GAN may also include a discriminator function configured to filter the generated set of alternative actionable visual screens using criteria defined by the determined expected user inquiry.

The GAN may include selective access to a database of actionable visual screen designs and layouts and a library of components for the alternative actionable UIs.

A method of generating in real-time an ad hoc actionable user interface (UI) and user experience (UX) is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a vehicle including a visual display device and a system using an electronic controller to generate in real-time an ad hoc actionable user interface (UI) and user experience (UX), according to the disclosure.

FIG. 2 is a schematic view of a representative actionable visual screen presented on the visual display device shown in FIG. 1.

FIG. 3 is a schematic illustration of a layout of the system for generating the ad hoc actionable UI and UX, shown in FIG. 1, according to the disclosure.

FIG. 4 is a schematic illustration of Markov Decision Process (MDP), as applied to the generation of the ad hoc UI and UX, employed by a UX algorithm programmed into the electronic controller, according to the disclosure.

FIG. 5 is a schematic illustration of a representative generative tree created by the UX algorithm using MDP shown in FIG. 4, according to the disclosure.

FIG. 6 is a schematic illustration of information flow between individual components in the system for generating the ad hoc actionable UI and UX, shown in FIG. 1, generated by a UI algorithm programmed into the electronic controller, according to the disclosure.

FIG. 7 is a flow diagram of a method configured to generate in real-time an ad hoc actionable UI and UX shown in FIGS. 1-6, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above”and “below”refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

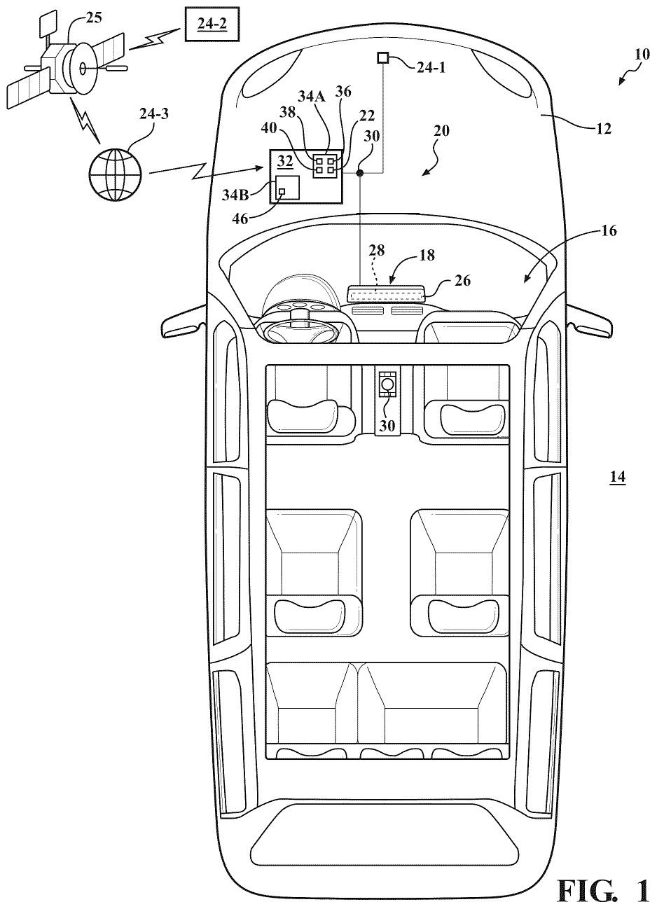

Referring to the drawings, wherein like reference numbers refer to like components throughout the several views, FIG. 1 schematically depicts a vehicle 10. The vehicle 10 is generally characterized by a vehicle body 12 surrounded by an external environment 14. The vehicle body 12 defines a vehicle interior or cabin 16 configured to accommodate a vehicle operator and passenger(s), for example in a generally seated position, and a vehicle infotainment system 18. With continued reference to FIG. 1, a system 20 operative from the vehicle cabin 16 is configured to facilitate generation, in real-time, of an ad hoc actionable user interface (UI) and user experience (UX) 22 (to be discussed in detail below). Although system 20 may be implemented in a variety of environments and settings, description of the subject system will henceforth be described primarily with respect to motor vehicle 10. With respect to the vehicle 10 environment, the vehicle operator and passenger(s) may be the intended users of the system 20.

The system 20 includes data sources, such as vehicle sensors 24-1, an information technology (IT) cloud server 24-2 and the World Wide Web (WWW) 24-3 in remote wireless communication with the vehicle 10 via a cellular or wireless fidelity (Wi-Fi) connection and a global positioning satellite (GPS) 25 for localization and positioning. The system 20 also includes a visual display device 26, shown as being arranged inside the cabin 16 and configured to present information using changeable or selectable and actionable visual screens 28. With respect to visual display screens 28, the term “actionable” denotes user interactive screens configured to elicit further action on the part of the system user and generate a resultant system response. The in-vehicle visual display device 26 may be part of the vehicle infotainment system 18 with connections to a navigation system and a GPS antenna, and in communication with vehicle cameras and other sensors. Alternatively, the visual display device 26 may be a mobile device, such as a cellular telephone or a laptop, running a mobile software application. The system 20 additionally includes an input device 30, such as a user operated keyboard, selector, or mouse, or a vehicle BUS terminal. The input device 30 is generally configured to receive external triggers, e.g., user inquiries, entries, or selections, signals corresponding vehicle operating parameters, trouble codes, etc.

System 20 further includes an electronic controller 32 in communication with the data source(s), e.g., 24-1, 24-2, 24-3, the visual display device 26, and the input device 30. Within the context of vehicle 10, each of the visual display device 26, the input device 30, and the electronic controller 32 may be a component of the vehicle infotainment system 18. As part of the system 20, the vehicle infotainment system 18 additionally includes a GPS antenna and a receiver (for communicating with the GPS 25), and is configured to access various applications and maps, either online or onboard the vehicle, i.e., programmed into the electronic controller 32. The electronic controller 32 may be a central processing unit (CPU) configured to receive data signals from various vehicle sensors and regulate operation of vehicle systems. The electronic controller 32 includes a memory that is tangible and non-transitory. The controller memory may be a recordable medium that participates in providing computer-readable data or process instructions. Such a medium may take many forms, including but not limited to non-volatile media and volatile media.

Non-volatile media used by the electronic controller 32 may include, for example, optical or magnetic disks and other persistent memory. Volatile media of each of the controller's memory may include, for example, dynamic random-access memory (DRAM), which may constitute a main memory. Such instructions may be transmitted by one or more transmission medium, including coaxial cables, copper wire and fiber optics, including the wires that comprise a system bus coupled to the vehicle systems. Memory of the electronic controller 32 may also include a flexible disk, hard disk, magnetic tape, other magnetic medium, a CD-ROM, DVD, other optical medium, etc. The electronic controller 32 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry.

Algorithms required by the electronic controller 32 or accessible thereby may be programmed in the controller, stored in the memory, and automatically executed to provide the required functionality. Specifically, the electronic controller 32 is programmed with a UI algorithm 34A and a UX algorithm 34B for operating the system 20 and tasked with generating in real-time, on-the-fly ad hoc actionable user interface (UI) and user experience (UX) 22. In the context of vehicle 10, the ad hoc actionable UI and UX 22 generally takes the form of a user interactive display screen or flow, i.e., chain, of screens for the display device 26. In the present context, the term “ad hoc” defines a user interface or actionable visual screen that is not designed or constructed in advance.

The UI algorithm 34A is configured to receive from the input device 30 a signal or code indicative of a trigger event 36, which may, for example, be a vehicle user entry or selection or a vehicle system alert. The UI algorithm 34A is also configured to request and receive, from the data source(s), e.g., 24-1, 24-2, 24-3, data 38 contextually related to the received trigger event 36. The UI algorithm 34A is additionally configured to determine or predict an expected subsequent user inquiry 40 (shown in FIGS. 1, 3, and 6), or system 20 interaction via the input device 30 in response to the received trigger event 36 and the contextually related data 38. With respect to the user, the contextually related data 38 may be deemed reasonably relevant in assisting decision-making or forming a solution to a likely concern defined by the trigger event 36.

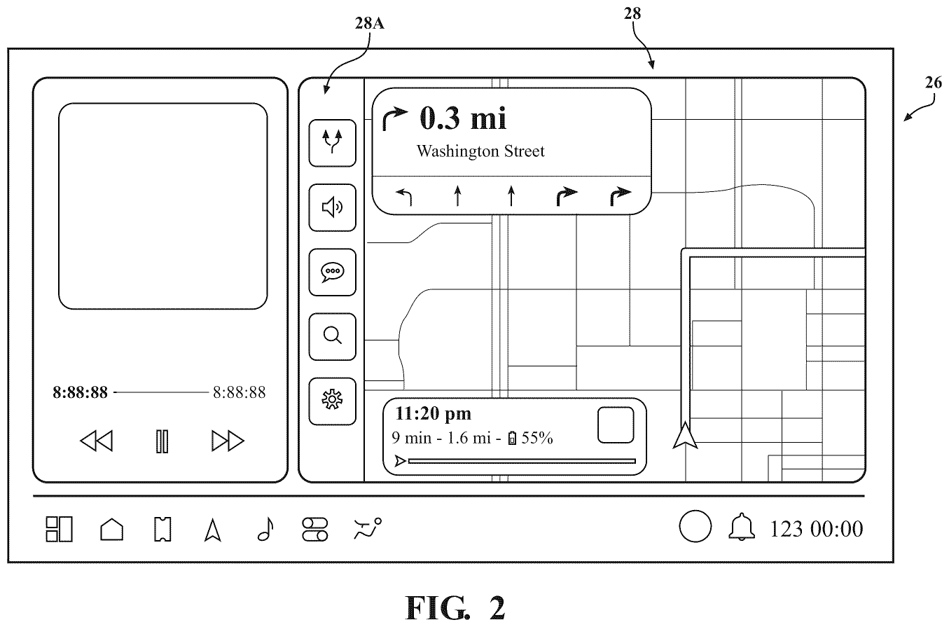

The UI algorithm 34A is further configured to use the determined expected user inquiry 40 to generate an actionable visual screen or a flow of linked actionable visual screens 28. As shown in FIG. 2. each of the generated actionable visual screen(s) 28 includes one or more user prompts 28A, e.g., selectable virtual “buttons”, corresponding to the determined expected user inquiry 40 and intended to link consecutive (first, second, third, etc.) visual screens 28 in a generated chain 42 of screens. The UI algorithm 34A may have access to and be configured to determine the expected user inquiry 40 via an artificial intelligence (AI) agent 44 using machine learning, such as a generative pre-trained transformer (GPT). The UX algorithm 34B is configured to select and present on the visual display device 26 an actionable visual screen 28 from generated actionable visual screen(s) to thereby generate the ad hoc actionable UI and UX 22. The presented actionable visual screen 28 may define a starting point for a flow of linked actionable visual screens in response to the user's selection via the prompt(s) 28A. The UX algorithm 34B may use Markov Decision Process (MDP) to determine or predict a likely flow of visual screens 28 based on the expected user inquiry 40.

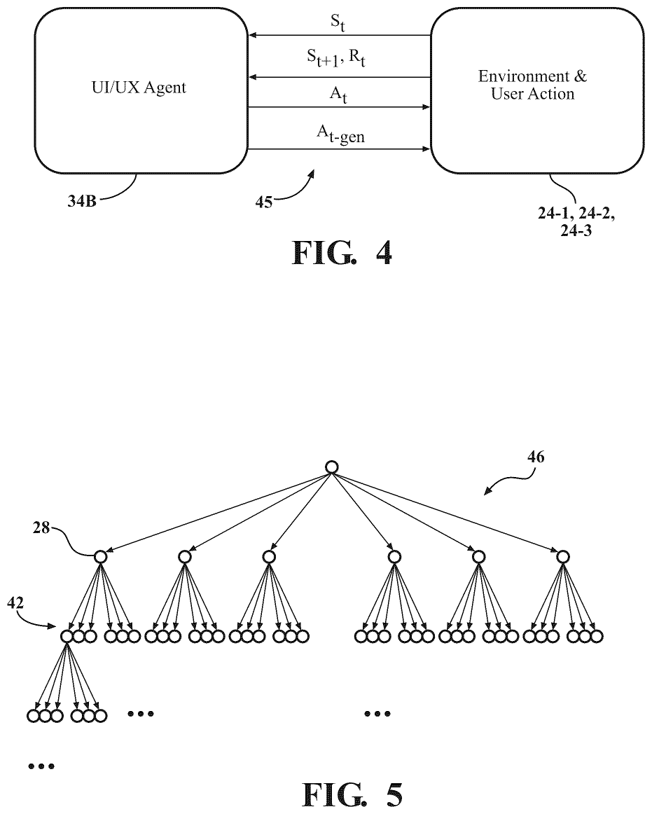

Markov decision process, or a stochastic control problem, is a model for sequential decision making when outcomes are uncertain. An MDP builds on the idea of a Markov chain but adds the element of decision-making. In an MDP, an agent makes decisions that influence the transitions between states. Each decision (or action) taken in a particular state leads to a probability distribution over the next possible states, similar to a Markov chain. However, unlike a simple Markov chain, in an MDP, the agent may actively choose actions to optimize a certain objective, usually maximizing some cumulative reward. FIG. 4 illustrates the UX algorithm 34B using MDP 45 to determine the expected user inquiry 40 via optimization of a reward function Rₜ. In FIG. 4, Sₜ represents current status of and information related to the interface design, while Sₜ₊₁ represents the status of the interface design at a subsequent timeframe or the next moment in time. Aₜ represents feasible actions available to the UX algorithm 34B carried out by the UX algorithm which depend on the current state Sₜ. A_{t-gen} represents generative actions that the system 20 creates (using an artificial intelligence algorithm), based on the determined expected user inquiry 40. A generative tree 46 of likely chain or flow 42 of visual screens 28 created on-the-fly by the UX algorithm 34B (using MDP 45 illustrated in FIG. 4) based on the expected user inquiry 40 is shown in FIG. 5.

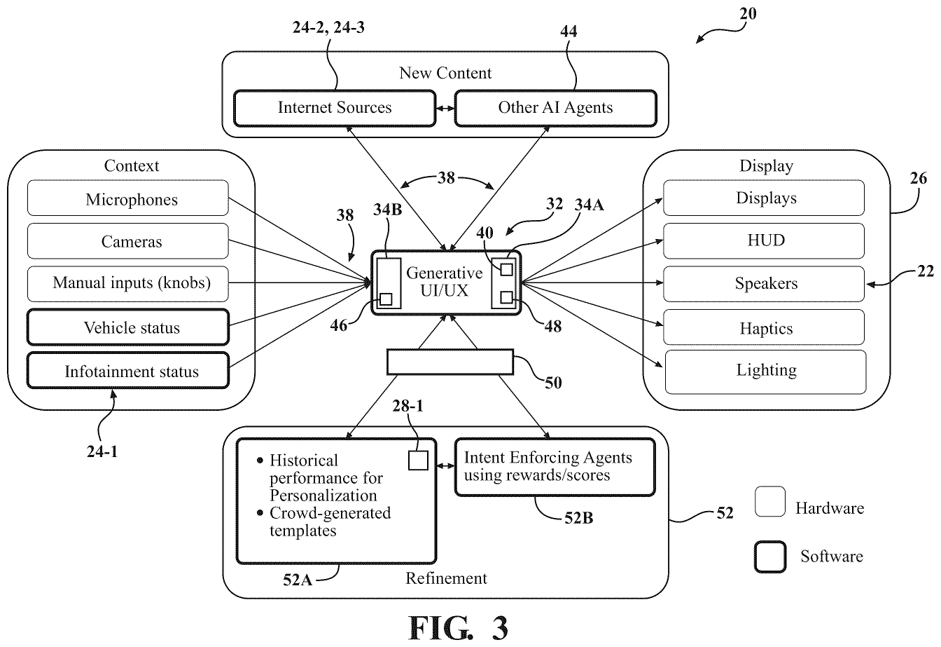

As shown in FIG. 3, the UI algorithm 34A may be further configured to construct, in real-time, a software code 48 configured to select a design and a layout of the actionable visual screen(s) 28. Thus constructed, the software code 48 is intended to include access to a UI formulator 50 configured to generate the actionable visual screen(s) 28. For example, the UI formulator 50 may include access to a generative adversarial network (GAN) 52. Generally, a generative adversarial network is a class of machine learning frameworks that approach generative AI. In a GAN, two neural networks contest with each other in the form of a zero-sum game, where one agent's gain is another agent's loss. Given a training set, this technique learns to generate new data with the same statistics as the training set. The core idea of a GAN is based on “indirect” training through a discriminator - another neural network that is used to tell how “realistic” the input seems - which itself is also being updated dynamically. As a result, the generator is not trained to minimize the difference versus a specific image or target result, but rather to fool the discriminator. Such an approach enables the GAN model to learn in an unsupervised manner.

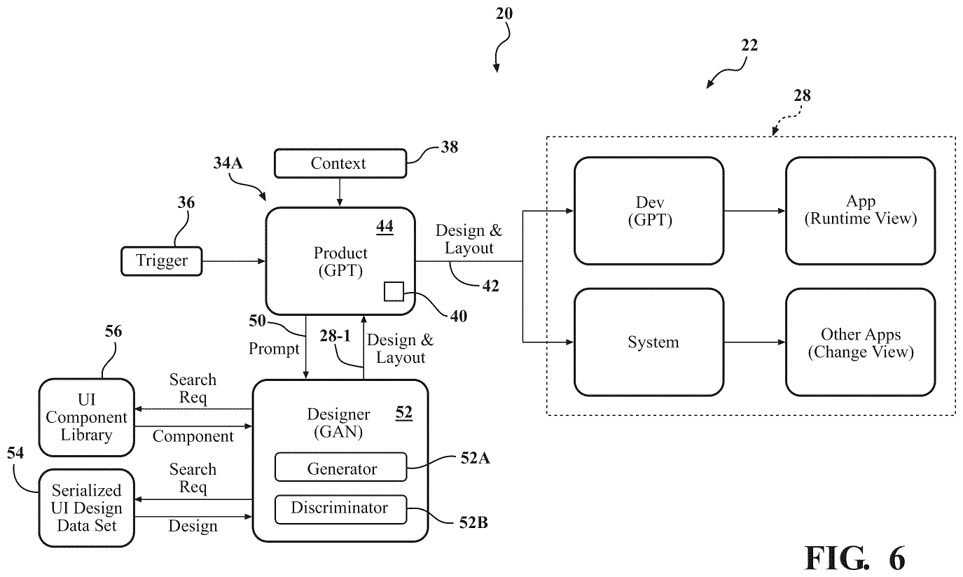

With continued reference to FIG. 3, the employed GAN 52 may thus include a design originator function 52A configured to generate a set 28-1 of actionable visual screen(s) 28. The GAN 52 may additionally include a discriminator function 52B configured to filter the generated set 28-1 of alternative actionable visual screen(s) 28 by assessing how closely each of the visual screen(s) 28 satisfies criteria defined or set by the determined expected user inquiry 40. The discriminator function 52B may be additionally configured to limit the generated content to comply with predefined actionable visual screen constraints, such as space, color, font, length of text, grouping, etc., in the generated set 28-1 of alternative actionable visual screen(s) 28. The GAN 52 may include selective access to a database 54 of interactive display screen designs and layouts for selection into the set 28-1 of alternative actionable visual screens. The GAN 52 may also include selective access to a library 56 of screen components that may be used for constructing individual interactive visual display screens. Thus constructed, individual visual display screens 28 may be combined to formulate the set 28-1 of alternative actionable visual screens and generate the chain 42 or flow of screens for the ad hoc actionable UI and UX 22, as shown in FIGS. 3 and 6.

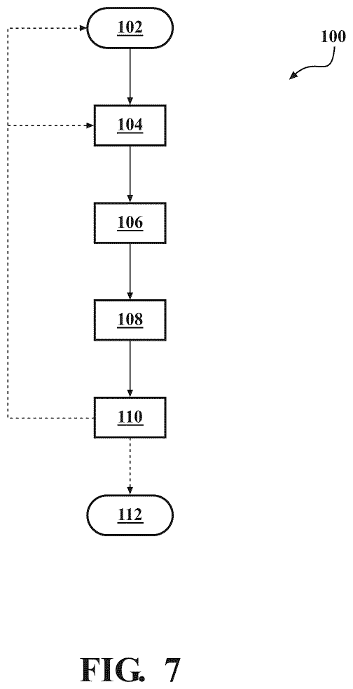

FIG. 7 depicts a method 100 of generating in real-time an ad hoc actionable user interface (UI) and user experience (UX) 22 via the system 20, as described above with respect to FIGS. 1-6. The method 100 may be implemented in the vehicle 10 using the vehicle's infotainment system 18 or in other settings using actionable visual screen(s) 28 for user interaction. The method 100 initiates in frame 102 with the electronic controller 32 receiving the trigger event 36 communicated by the input device 30. Following frame 102, the method proceeds to frame 104, where the method includes receiving, via the electronic controller 32, from the data source(s), such as vehicle sensors 24-1, the IT cloud server 24-2, and the World Wide Web (WWW) 24-3, data 38 contextually related to the received trigger event 36.

After frame 104, the method advances to frame 106. In frame 106 the method includes determining, via the UI algorithm 34A, the expected user inquiry 40 in response to the received trigger event 36 and contextually related data 38 received from the data source(s). As described relative to FIG. 6, the expected user inquiry 40 may be determined by the UI algorithm 34A using the AI agent 44. For example, the UI algorithm 34A may use a pre-trained AI framework or model, such as GPT. Following frame 106, the method proceeds to frame 108.

In frame 108 the method includes generating, via the UI algorithm 34A, actionable visual screen(s) 28, each visual screen having one or more user prompts 28A corresponding to the determined expected user inquiry 40. In frame 108 the method may additionally include constructing, via the UI algorithm 34A, in real-time, software code 48 responsible for selecting the design and the layout of the ad hoc actionable UI and UX 22. In frame 108 the method may additionally include accessing, via the constructed software code 48, as described relative to FIG. 3, the UI formulator 50 for generating the ad hoc actionable UI and UX 22. The UI formulator 50 may in turn access the generative adversarial network (GAN) 52. As described relative to FIGS. 3 and 6, the GAN 52 may include the design originator function 52A for generating the set 28-1 of alternative actionable visual screen(s) 28 and the discriminator function 52B for filtering the generated set of alternative actionable screen(s) using criteria defined by the determined expected user inquiry 40.

In frame 108 the method may additionally include selectively accessing, via the GAN 52, the database 54 of actionable UI designs and layouts and the library 56 of components for the set 28-1 of alternative actionable visual screen(s) 28. From frame 108, the method proceeds to frame 110. In frame 110 the method includes selecting and presenting on the visual display device 26, via the UX algorithm 34B, an actionable visual screen 28 from the generated actionable visual screen(s) to thereby generate the ad hoc actionable UI and UX 22 In frame 110, as described with respect to FIG. 4, the method may include determining the expected user inquiry by the UX algorithm 34B via Markov Decision Process (MDP). Additionally, the UX algorithm 34B may create on-the-fly a generative tree 46 of likely flow of visual screens 28 based on the expected user inquiry 40 using MDP as shown in and described relative to FIG. 5.

After frame 110, the method may loop back to frame 102 for receiving another trigger event 36 via the input device 30, such as by the system or vehicle user, to establish a flow of user interactive screens. Additionally, method 100 may permit changes to be implemented to the ad hoc actionable UI and UX 22 via screen regeneration on the visual display device 26 or via other feedback, by returning to frame 104. Alternatively, method 100 may conclude in frame 112 once the ad hoc actionable UI and UX 22 has been generated, the flow of user interactive screens has been displayed, and the user inquiry has ended.

Overall, the real-time, on-the-fly generation of ad hoc actionable UIs is intended to enhance user experience and interface flows with personalized, up-to-date content. The system 20 and method 100 enable a visual display device to generate in real-time actionable user interface(s) for unplanned situations and using data that may not have been available when the display device or the host vehicle were manufactured. System 20 and method 100 are also configured to obtain data and content updates from the cloud and generative knowledge agents to enable creation of actionable user interface(s) with information and screen designs specifically adapted to unforeseen situations and user inquiries.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for generating in real-time an ad hoc actionable user interface (UI) and user experience (UX), the system comprising:
at least one data source;
a visual display device configured to present actionable visual screens;
an input device configured to receive external triggers;
an electronic controller in communication with the at least one data source, the visual display device, and the input device and programmed with a UI algorithm and a UX algorithm, wherein the UI algorithm is configured to:
receive, from the input device, a trigger event;
receive, from the at least one data source, data contextually related to the received trigger event;
determine an expected user inquiry in response to the received trigger event and contextually related data received from the at least one data source; and
generate at least one actionable visual screen, each having one or more user prompts corresponding to the determined expected user inquiry; and
wherein the UX algorithm is configured to select and present on the visual display device an actionable visual screen from the at least one generated actionable visual screen to thereby generate the ad hoc actionable UI and UX.

2. The system of claim 1, wherein each of the visual display device, the input device, and the electronic controller is a component of a vehicle infotainment system.

3. The system of claim 2, wherein the at least one data source includes at least one of a vehicle sensor, an information technology (IT) cloud server, and World Wide Web (WWW).

4. The system of claim 1, wherein the UI algorithm is configured to determine the expected user inquiry via an artificial intelligence (AI) agent.

5. The system of claim 4, wherein the UX algorithm uses Markov Decision Process (MDP) to determine the expected user inquiry.

6. The system of claim 5, wherein the expected user inquiry is determined via optimization of a reward function defined using the trigger event and the contextually related data.

7. The system of claim 1, wherein the UI algorithm is additionally configured to construct, in real-time, a software code configured to select a design and a layout of the at least one actionable visual screen.

8. The system of claim 7, wherein the constructed software code includes access to a UI formulator configured to generate the at least one actionable visual screen.

9. The system of claim 8, wherein the UI formulator includes access to a generative adversarial network (GAN) having:
a design originator function configured to generate a set of alternative actionable visual screens; and
a discriminator function configured to filter the generated set of alternative actionable visual screens using criteria defined by the determined expected user inquiry.

10. The system of claim 9, wherein the GAN includes selective access to:
a database of actionable visual screen designs and layouts; and
a library of components for the set of alternative actionable visual screens.

11. A method of generating in real-time an ad hoc actionable user interface (UI) and user experience (UX), the method comprising:
receiving, via an electronic controller programmed with a UI algorithm, a trigger event from an input device configured to receive external triggers;
receiving, via the electronic controller, from an at least one data source, data contextually related to the received trigger event;
determining, via the UI algorithm, an expected user inquiry in response to the received trigger event and the contextually related data received from the at least one data source;
generating, via the UI algorithm, at least one actionable visual screen, each having one or more user prompts corresponding to the determined expected user inquiry; and
selecting and presenting on a visual display device, via the UX algorithm, an actionable visual screen from the at least one generated actionable visual screen to thereby generate the ad hoc actionable UI and UX.

12. The method of claim 11, wherein each of the visual display device, the input device, and the electronic controller is a component of a vehicle infotainment system.

13. The method of claim 12, wherein the at least one data source includes at least one of a vehicle sensor, an information technology (IT) cloud server, and World Wide Web (WWW).

14. The method of claim 11, wherein determining the expected user inquiry is accomplished by the UI algorithm via an artificial intelligence (AI) agent.

15. The method of claim 14, wherein determining the expected user inquiry is accomplished by the UX algorithm via Markov Decision Process (MDP).

16. The method of claim 15, wherein determining the expected user inquiry is accomplished via optimization of a reward function defined using the trigger event and the contextually related data.

17. The method of claim 11, further comprising constructing, via the UI algorithm, in real-time, a software code configured to select a design and a layout of the ad hoc actionable UI.

18. The method of claim 17, further comprising accessing, via the constructed software code, a UI formulator configured to generate the ad hoc actionable UI.

19. The method of claim 18, further comprising:
accessing, via the UI formulator, a generative adversarial network (GAN) having:
a design originator function configured to generate a set of alternative actionable visual screens; and
a discriminator function configured to filter the generated set of alternative actionable visual screens using criteria defined by the determined expected user inquiry; and
selectively accessing, via the GAN:
a database of actionable visual screens designs and layouts; and
a library of components for the set of alternative actionable visual screens.

20. A system for generating in real-time an ad hoc actionable user interface (UI) in a motor vehicle, the system comprising:
at least one data source; and
a vehicle infotainment system including:
a visual display device configured to present actionable visual screens;
an input device configured to receive external triggers;
an electronic controller in communication with the at least one data source, the visual display device, and the input device and programmed with a UI algorithm and a UX algorithm, wherein the UI algorithm is configured to:
receive, from the input device, a trigger event;
receive, from the at least one data source, data contextually related to the received trigger event;
determine, via an artificial intelligence (AI) agent, an expected user inquiry in response to the received trigger event and contextually related data received from the at least one data source; and
generate at least one actionable visual screen, each having one or more user prompts corresponding to the determined expected user inquiry; and
wherein the UX algorithm is configured to select and present on the visual display device an actionable visual screen from the at least one generated actionable visual screen to thereby generate the ad hoc actionable UI and UX.
